(19) United States
(12) Patent Application Publication
(10) Pub. No.: US 2014/0075766 A1
(43) Pub. Date: Mar. 20, 2014

(54) Tracing Assistance Assembly

(71) Applicant: Jeanette Pongratz-Doyle, Nanaimo (CA)

(72) Inventor: Jeanette Pongratz-Doyle, Nanaimo (CA)

(21) Appl. No.: 14/030,209

(22) Filed: Sep. 18, 2013

Related U.S. Application Data
(60) Provisional application No. 61/702,957, filed on Sep. 19, 2012.

(51) Int. Cl. B43L 13/00

(52) U.S. Cl. CPC B43L 13/00
USPC 33/27.12

(57) ABSTRACT

The present invention describes a new and improved pattern tracing device that enables accurate tracing of irregularly shaped objects. The device includes a plurality of tracing assistance sleeves of various sizes for creating tracings of different objects with a given offset therefrom. The tracing sleeves are slid over the working end of a pencil and are attached to the writing end the pen. The tracing guide ends of the sleeves are pointed or square and the sleeves are held in place on the pencil and at a fixed distance from the irregularly shaped object while the user traces out the design matching that of the object.

### CROSS REFERENCE TO RELATED APPLICATION

This application claims the benefit of U.S. Provisional Application No. 61/702,957 filed on Sep. 19, 2012, entitled “Perfect Framer/Resizer.” The above identified patent application is herein incorporated by reference in its entirety to provide continuity of disclosure.

### BACKGROUND OF THE INVENTION

1. Field of the Invention

The present invention relates to a device for tracing objects. More specifically the invention relates to a device for tracing irregularly shaped objects comprising a sleeve that attaches onto the working end of a writing mechanism and enables a constant separation from the irregularly shaped object while the user traces a pattern around the object.

The frame of a picture or photograph borders the image and is often just as important as the image itself and provides a framework for how the artist wishes to present their artwork. The framing can aid in facilitating an intended mood for the artwork, enhance the aesthetic value of the art, or assist in facilitating an illusion of being in a certain time period.

Picture frames can vary greatly in size, materials, and differences in design. The frames can provide a border of a large or a very small scale around the picture and can even be adorned with design elements such as jewels or intricate moldings and decorations to improve the presentation of the artwork. Sometimes, however, a user does not require a large frame around a picture, but instead may need to provide borders for pictures that are sized to fit within a scrapbook. Just plainly inserting the pictures into a scrapbook does not assist in portraying the mood, importance, or excitement of the moments surrounding the picture. To add some personality to the picture, users often attempt to alter the picture by cutting it into a shape that focuses on the main items in the picture and also may provide a background to enable the picture to stand out from the page on which the picture is attached to.

Typical frames are manufactured into a uniform shape that matches the shape of the picture; however, when a user wishes to have a border around their picture that is of an irregular shape they are left to create the border themselves. There are many issues that arise when a user tries to create a border around an irregularly shaped picture and attempts at layering matching irregularly shaped borders come with many difficulties. It is extremely taxing to attempt to duplicate patterns at a larger scale and copying patterns that have random angles and curves is not an easy task. Furthermore, it is very important that an irregularly shaped design is copied correctly because minor contrasts between the picture and border shape stand out greatly.

There are several devices that attempt to assist a user in the construction of a background that matches that of a picture. These devices come in the form of tracing systems that are designed to assist in tracing in straight or curved lines. The setbacks of these systems is that they often have difficulty copying complex or irregular shapes at different scales than the original outline. Additionally some of the devices are bulky and are not convenient for transportation or for use of copying a variety of shapes. What is needed is a device that is adapted to enable a user to accurately duplicate shapes at a variety of sizes so that they can produce borders that aesthetically suit their needs. Furthermore the device should be convenient for use with a variety of shapes and should be compact enough for easy transportation.

The present invention relates to an assembly for assisting a user in duplicating a pattern at a scale that is offset (larger or smaller) than the original design. The assembly is lightweight, can be used with pens or pencils, and has an edge that facilitates accurate duplication of a pattern. The assembly includes a pen or a pencil, and a plurality of interchangeable tracing sleeves. Furthermore, the assembly can be included in a kit containing lead refills for a pencil, a storage tray, a rotary cutter, decorative pinking shears, a cutting mat, and a case. For assembly of the tracing assisting assembly, a tracing sleeve of a desired size is selected from the plurality of tracing sleeves. The tracing sleeve is then slipped over the working end of the tracing utensil until it becomes secured on the writing utensil. The user may then follow an existing pattern and create a duplicated pattern at a scale that is equivalent to the size of the selected tracing sleeve. In this way, the present invention provides a framing and resizing tool that allows artists and crafters to create frames, borders, patterns and stencils in custom shapes and sizes quickly and without a host of cumbersome or complicated equipment.

2. Description of the Prior Art

Devices have been disclosed in the prior art that relate to the duplication of patterns. These include devices that have been patented and published in patent application publications. These devices generally relate to a tracing assistance assembly that quickly and efficiently enables a user to duplicate a pattern of different sizes compared to that of the original design. The following is a list of devices deemed most relevant to the present disclosure, which are herein described for the purposes of highlighting and differentiating the unique aspects of the present invention, and further highlighting the drawbacks existing in the prior art.

Specifically U.S. Pat. No. 228,062 to Gregory describes a pencil attachment for pantographs. The attachment is adapted for copying, enlarging, or reducing drawings. The attachment comprises a series of slats comprising a plurality of holes. The slats are jointed together at holes to determine the size of the copied drawing and a writing pin is inserted through one of the joints. While the pantograph attachment of Gregory is similar in nature and relevant to the present invention, it differs in that it fails to provide a more compact copying attachment, and further differs in failing to enable quick adjustment between sizes of copies.

U.S. Pat. No. 3,835,541 to Whitworth teaches an ellipsoid marker and template tracer for determining aperture cutting sizes for the lateral mating of two pipes. The device is capable of drawing templates on the pipes for cutting at a later time. However, while the tracer of Whitworth is similar in nature and relevant to the present invention, it differs in that it fails to provide tracings for complex shapes. Furthermore the tracer of Whitworth is a large device and fails to provide quick adjustments between sizes of traces.

U.S. Pat. No. 6,021,575 to Thieben describes a tracing system for tracing complex profile shapes. The system includes a right triangular base having a spring-loaded holder, onto which a writing component is attached. To sketch a duplicate template, the base is positioned against the material, wherein the writing component is perpendicular to the sketch. However, although the tracing system of Thieben is similar in nature and relevant to the present invention, it differs in that it fails to provide a compact assembly, and further fails to provide a quick and efficient system for altering the size of the tracing.

U.S. Pat. No. 7,600,326 to Plucknett describes an instrument for duplicating complex shapes. The instrument includes a base and a linear measure that is rotatably connected to the base. The linear measure enables measuring of a distance to the corners of an outline to be copied and is capable of following the angles intended to be copied. The device can further include a means for recording the linear and angular measurement for each corner of the object for duplication at a separate time on a separate surface. While the tracing instrument of Plucknett is similar in nature and relevant to the present invention, it differs in that it fails to provide a compact assembly, and further fails to provide a quick and efficient system for altering the size of the tracing.

U.S. Patent Publication No. 2005/0188799 to Kocienski teaches a layout design tool for laying out designs on paper, in particular for laying out designs in scrapbooks. The tool enables a scrapbook designer to first lay out a design before having to commit a permanent design on the book. The tool includes a substantially flat base portion and a plurality of shaped portions that are detachably mounted on the flat base portion. Although the layout design tool of Kocienski is similar in nature and relevant to the present invention, it differs in that it fails to provide a compact assembly, and further fails to provide a quick and efficient system for altering the size of the tracing.

The present invention relates to a new and improved assembly for enabling a user to duplicate an irregularly shaped pattern at a scale that is larger or smaller than the original design. The assembly is used in conjunction with a writing utensil and has an offset edge that provides constant spacing from a picture, thus enabling an exact copy of the exterior of the picture. The assembly includes a pen or a pencil, and a plurality of interchangeable sleeves that attach to the writing utensils over the working ends and are secured thereon. Furthermore, the sleeves can come in offset edges that include right, triangular, and curved angles to enable tracing that corresponds with different patterns. The assembly can be included in a kit containing lead refills for a pencil, a storage tray, a rotary cutter, decorative pinking shears, a cutting mat, and a case. The sleeves range in diameter from ¼ of an inch to 2 inches, however it is within the scope of the invention to provide larger or smaller tracing sleeves. To copy a border around a picture, first a tracing sleeve is selected from the plurality of tracing sleeves. The sleeve is then slipped over the writing utensil until it becomes secured thereon. The user then traces around the picture or existing border while maintaining the offset edge against the article to be bordered to create a larger border that is identical in shape to the original.

In view of the drawbacks of the prior art devices, it is shown that the prior art has several known setbacks and that the present invention is substantially divergent in design elements from the prior art and subsequently it is clear that there is a need in the art for an improvement to existing tracing assemblies. In this regard the instant invention substantially fulfills these needs.

### SUMMARY OF THE INVENTION

In view of the foregoing disadvantages inherent in the known types of tracing assemblies now present in the prior art, the present invention provides a new tracing article and assembly that can be utilized for providing convenience for the user when a quickly interchangeable attachments for tracing irregularly shaped objects is desired.

The tracing assembly is designed for those who want to trace borders around irregularly shaped objects. The assembly comprises a pen or pencil and a plurality of sleeves of different diameters that are configured to enable the tracing of an object at a distance from the object.

The sleeves of the present invention are sized to fit a common writing utensil or a specialized pencil that comprises a locking pin that secures the tracing sleeve to the pencil. Furthermore, the sleeves are adapted to be quickly interchangeable to enable a layering of borders, and additionally, the assembly can include a kit having shears, a rotary cutter, and a case.

It is therefore an object of the present invention to provide a new and improved tracing assembly that has all of the advantages of the prior art and none of the disadvantages.

It is another object of the present invention to provide a tracing assembly adapted for tracing irregularly shaped objects to create a defined and uniform border therearound.

Another object of the present invention is to provide a tracing assembly having interchangeable tracing sleeves.

Yet another object of the present invention is to provide a tracing assembly that quickly adjust the tracing offset distance from the article being framed, bordered and patterned.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 illustrates the preferred embodiment of the tracing assembly of the present invention.

FIG. 2 illustrates a separated view of the preferred embodiment of the tracing assembly of the present invention.

FIG. 3 illustrates a close-up view of the working end of the preferred embodiment of the present invention.

FIG. 4 illustrates a plurality of the attachment sleeves of differing offsets.

FIG. 5 illustrates a perspective view of the invention in use.

FIG. 6 illustrates an embodiment of the attachment sleeve that includes marked indicia thereon for tracing about an object without placing the end of the sleeve thereagainst and using one's eye to gauge the offset distance.

### DETAILED DESCRIPTION OF THE INVENTION

Reference is made herein to the attached drawings. Like reference numerals are used throughout the drawings to depict like or similar elements of the tracing assembly. For the purposes of presenting a brief and clear description of the present invention, the preferred embodiment will be discussed as used for an assembly for tracing irregularly shaped objects. The figures are intended for representative purposes only and should not be considered to be limiting in any respect.

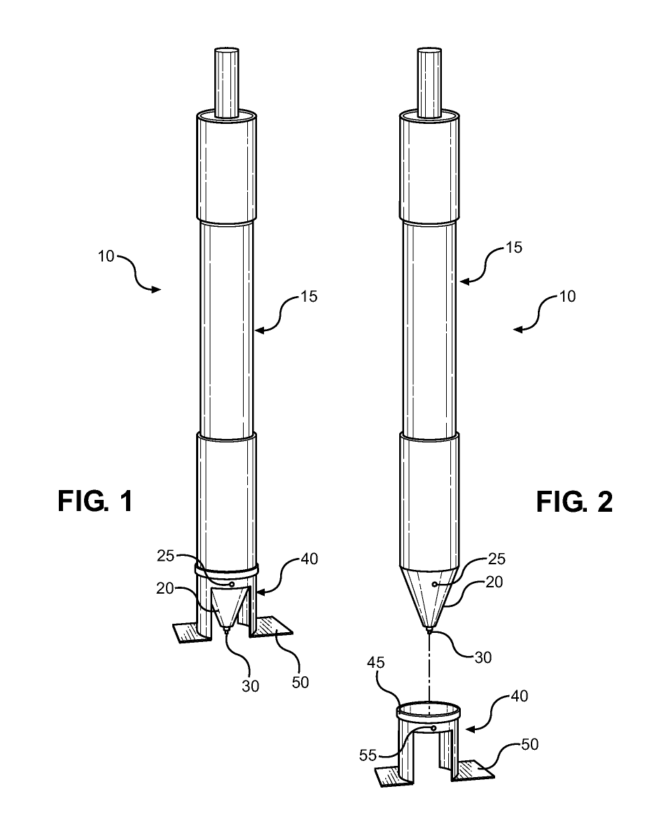

Referring now to FIG. 1, there is shown the preferred embodiment of the tracing assembly of the present invention. The tracing assembly 10 is designed to enable accurate copying of irregularly shaped flat objects. The tracing assembly 10 includes a writing utensil 15 and a tracing sleeve 40. The sleeve 40 is attached to the working end 20 of the writing utensil 15 to enable a consistent offset distance between the object to be traced and the tip 30 of the writing utensil 15.

Referring now to FIG. 2, there is shown a view of the preferred embodiment of the tracing assembly 10 of the present invention, wherein the writing utensil 15 is separated from the tracing sleeve 40. The writing utensil 15 may be one of a pen, pencil, marker or a highlighter. The writing utensil 15 includes a locking pin 25 located on a working end 20 of the writing instrument 15, and a writing end. The locking pin 25 is spring biased from within the working end 20 of the writing utensil 15 and is adapted for securing within the tracing sleeve 40 and into an aperture 55 therein.

The tracing sleeve 40 of the tracing assembly 10 includes a securing collar 45, one or more flanges 50, and an aperture 55 within the collar 45. To connect the writing utensil 15 to the tracing sleeve 40, the securing collar 45 of the sleeve 40 is inserted over the working end 20 of the writing utensil 15. The securing collar 45 has an aperture 55, wherein when the collar 45 is inserted over the working end 20 of the writing utensil 15, the locking pin 25 of the working end 20 becomes secured within the aperture 55. To remove the tracing sleeve 40 from the writing utensil 15, the locking pin 25 of the working end 20 is pressed down against the spring bias of the locking pin 25. The pin 25 retracts into the body of the working end 20 in order to facilitate removal of the tracing sleeve 40.

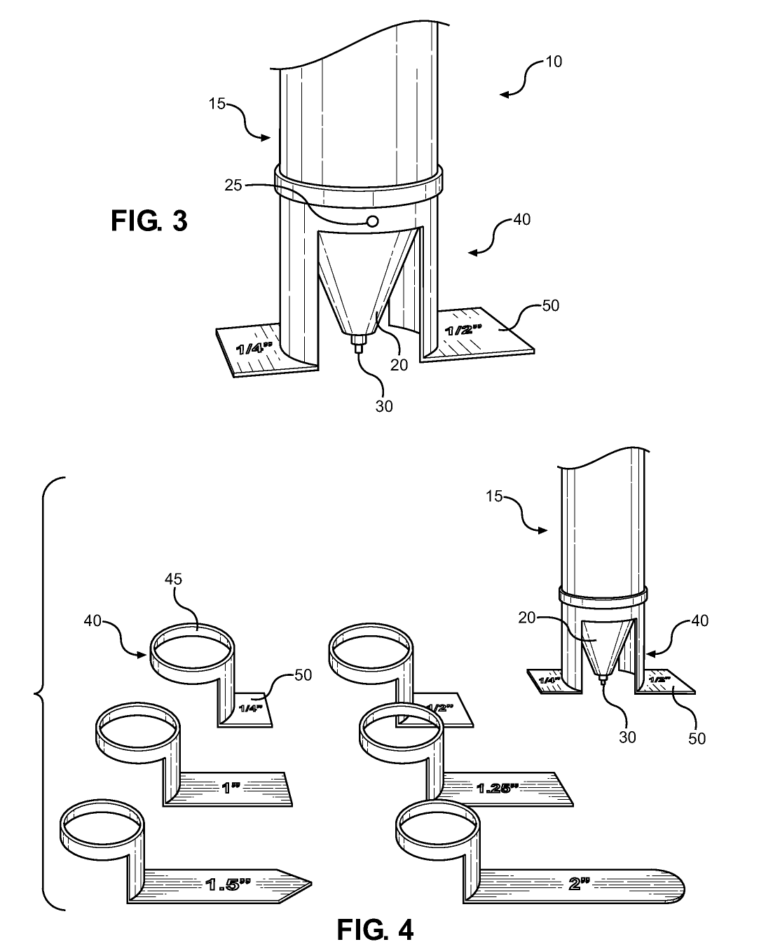

Referring to FIG. 3, there is shown an enhanced view of the writing utensil 15 and tracing sleeve 40 of the preferred embodiment of the assembly 10 of the present invention. The tracing sleeve 40 includes dual tracing flanges 50 at given offset distances for tracing a border around an irregularly shaped object. The flanges 50 of the tracing sleeve 40 are configured to either lie flat against a tracing surface or be held thereabove when the locking pin 25 of the working end 20 of the writing utensil 15 is secured within an aperture of the tracing sleeve 40. For tracing objects having a thickness, it is desired that the flange 50 of the sleeve 40 be positioned above the level of the writing utensil working end 20, whereby the tip thereof extends beyond a plane prescribed by the lower surface of the flange 50. This allows the writing utensil to function across misaligned surfaces or across steps in thickness.

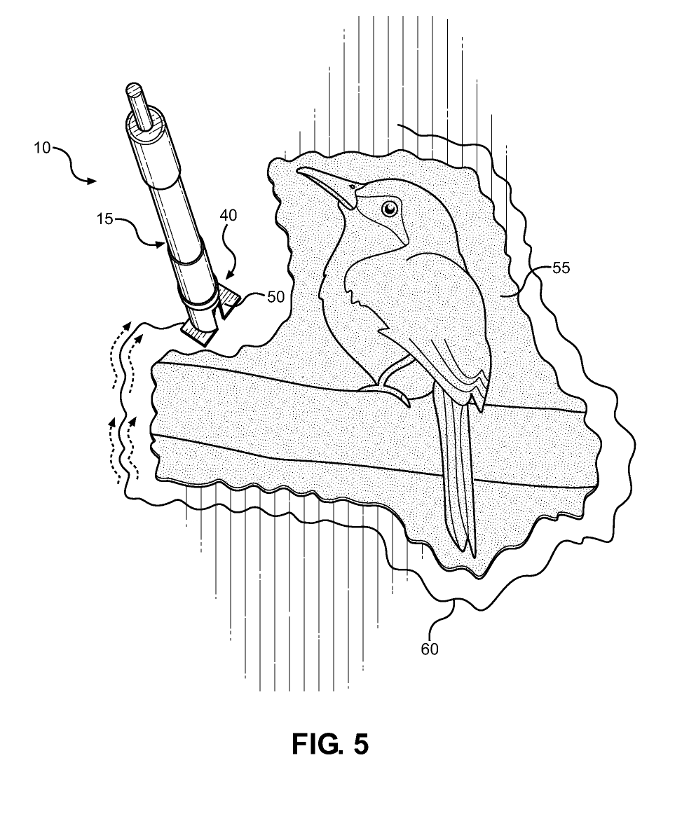

Referring to FIG. 4, there is illustrated an alternative embodiment of the tracing assembly 10 and a plurality of assorted tracing sleeves 40. The alternative tracing assembly 10 differs from the preferred embodiments of FIGS. 1-3 in that the embodiment of FIG. 4 lacks a locking pin on the working end 20 of the writing utensil 10, and the tracing sleeve 40 lacks an aperture for the reception of the locking pin.

The alternative embodiment of FIG. 4 further differs from the preferred embodiments of FIGS. 1-3, in that the alternative embodiment of FIG. 4 is adapted for use with a variety of writing utensils 15. For insertion onto a writing utensil 15, the securing collar 45 of the tracing sleeve 40 is inserted over the working end 20 of a writing utensil 15. The securing collar 45 of the tracing sleeve 40 is slid over the working end 20 of the writing utensil 15 until the sleeve 40 reaches a non-tapered section of the writing utensil 15. The diameter of the securing collar 45 is sized to enable the collar 45 to become secured by a friction fit onto the writing utensil 15.

The embodiment of FIG. 4 enables a user to quickly alternate between sizes and types of tracing sleeves 40. As shown, the tracing sleeves 40 range in sizes of lower, higher, and intermediate dimensions to provide different offset distances. The tracing sleeves 40 can comprise either one or two flanges 50, and can come in curved, triangular, or squared ends in order to facilitate more accurate tracings. Furthermore, the sleeves 40, can come with or without apertures for insertion onto the working end 20 of a writing utensil 15. Additionally, it is within the scope of the present invention to provide a tracing sleeve 40 including an aperture; wherein the securing collar 45 is sized and configured to secure onto one of a multitude of writing utensil 15 types that lack locking pins.

Referring to FIG. 5, there is shown a perspective view of the present invention in use. For use, first a photo 55 or other flat object is selected, and optionally altered by cutting or removing portions of the objects to the user's desire. Next, to duplicate the outline of the photo 55, the tracing assembly 10 traces a border 60 around the photo 55. Once the diameter of the outline of the border is decided, a tracing sleeve 40 of a corresponding flange 50 size is selected. The collar 45 of the sleeve 40 is inserted over the working end 20 of a writing utensil 15 until the sleeve 40 becomes secured onto the utensil 15 by a friction fit or by connection between the locking pin 25 of the writing utensil 15 and the aperture 55 of the tracing sleeve 40. The flange 50 then lies flat against a tracing surface with the writing end 30 in contact with a writing surface at the selected flange 50 distance. The edge of the flange 50 is placed adjacent to the border of the irregularly shaped object 55. The user then traces around the border of the object and creates an outline 60 that is identical to that of the photo 55, but is larger than the photo 55 itself. To remove the border 60, the user has to cut out the tracing 55. Furthermore, if the user wishes to layer an additional border of a larger diameter than the previously created border, the user can then switch to a tracing sleeve 40 of a different diameter and repeat the process.

The present invention is designed for users who wish to trace borders for irregularly shaped objects and provides an improved tracing assembly 10 configured for quick interchangeability between tracing diameters. The assembly 10 comprises a writing utensil 15 that is configured for connection to a tracing sleeve 40. The writing utensil 15, can be one of a pencil, pen, marker, or highlighter. Further, the writing utensil 15, includes a working end 20, a locking pin 25, and a writing end 30; wherein the locking pin 25 is adapted for securing the writing utensil 15 to the tracing sleeve 40. The tracing sleeve 40, includes a securing collar 45, one or two tracing flanges 50, and an aperture 55 located on the securing collar 45. The assembly 10 is assembled by inserting the securing collar 45 of the tracing sleeve 40 over the working end 20 of a writing utensil 15. The sleeve 40 is inserted along the writing utensil 15 until a locking pin 25 of the writing instrument 15 emerges from an aperture 55 of the tracing sleeve 40, thus securing the sleeve 40 onto the writing utensil 15 until the locking pin 25 is pressed down and the sleeve 40 is removed once the pin 25 is no longer contacting the aperture 55 of the tracing sleeve. Alternatively, for embodiments wherein the locking pin 25 is removed, the securing collar 45 of the tracing sleeve 40 is sized and configured to facilitate a friction fit with the body of the writing utensil 15.

The assembly 10 facilitates the ability of the user to add personality to their scrapbooks, pictures or artwork by not only providing a bordered background, but an actual frame on top of a picture by cutting a copy of the picture shape out of cardstock and choosing the size sleeve for depth of frame. Once chosen, the sleeve flange is placed on the inside edge of the shape for tracing around the shape of the picture (or similar article being traced). The user can then use a rotary cutter on the penciled edge to cut out the center giving you the perfect frame over the picture. This allows the user to create borders and offsets of larger or smaller size therearound.

The tracing assembly 10 of the present invention enables a user to accurately trace the exterior outline of a flat object, such as a photograph. The assembly includes tracing sleeves 40 that range offset size and are provided in curved, right and triangular angles to facilitate easier tracing of the object. Additionally, the assembly can be included in a kit containing lead refills for a pencil, a storage tray, a rotary cutter, decorative pinking shears, a cutting mat, or a case to assist in portability and storage.

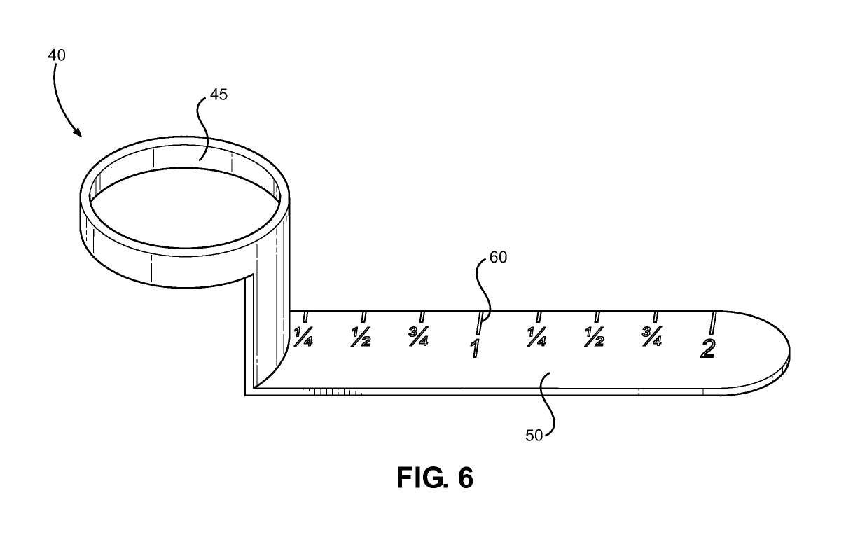

Referring now to FIG. 6, there is shown a view of an alternate embodiment of the present invention, wherein the flange 50 of the tracing sleeve 40 includes an elongated length and indicia 60 along the upper surface and along at least one edge thereof. In this embodiment, the writing utensil operates with a single tracing sleeve 40, and provides the user with the flexibility to offset the given border, pattern, or frame without interchanging between sleeves 40. This embodiment contemplates the user measuring the offset of the writing utensil by first choosing a desired offset distance, and then placing the indicia line 60 that corresponds with that desired offset distance along the edge of the article being operated upon and tracing therearound using the indicia line 60 and the user's skill to maintain the utensil offset. The securing collar 45 is secured in the same fashion as the aforementioned embodiments; however this embodiment utilizes more user skill in creating a uniform offset, trading that increased skill for improved efficiency with regard to offset switching.

The ability of the user to quickly change tracing attachments, as well as enabling the user to select between a plurality of attachment shapes that enable more accurate tracing of objects at a selected distance from the object. Additionally the assembly provides a desirable tracing assembly 10 for users intending to separate their artwork from others. The assembly 10 facilitates the ability of users to add some personality to their scrapbooks, pictures, and artwork by providing a bordering background to their artwork that matches the uniqueness of their artwork.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1. A tracing assembly adapted for tracing around an irregularly shaped object, comprising:
a writing utensil having a working end and a tip;
a tracing sleeve having an upstanding securing collar and one or more tracing flanges extending outward therefrom along a single plane;
said tracing sleeve being adapted to accept the working end of said writing utensil and position said tip in alignment with said single plane.

2. The tracing assembly of claim 1, wherein said writing utensil and said tracing sleeve comprise a friction fitting when said sleeve is inserted over said writing utensil working end.

3. The tracing assembly of claim 1, wherein:
said writing utensil further comprises a spring biased locking pin;
said securing collar of said tracing sleeve further comprising an aperture thereon;
said locking pin being adapted to secure within said aperture when said tracing sleeve is inserted over said writing utensil.

4. The tracing assembly of claim 1, wherein each of said tracing flanges comprise different offset lengths adapted for tracing around objects at different distances.

5. The tracing assembly of claim 1, wherein at least one of said tracing flange has a flat end.

6. The tracing assembly of claim 1, wherein at least one of said tracing flange has a pointed end.

7. The tracing assembly of claim 1, wherein at least one of said tracing flange has a rounded end.

8. The tracing assembly of claim 1, wherein:
said tracing flange further comprises an upper surface and a first and second edge;
measurement indicia along said upper surface and along at least one of side first and second edges.

9. A tracing article adapted for tracing around an irregularly shaped object, comprising:
a tracing sleeve having an upstanding securing collar and one or more tracing flanges extending outward therefrom along a single plane;
said tracing sleeve being adapted to accept the working end of a writing utensil and position a tip thereof in alignment with said single plane.

10. The tracing assembly of claim 9, wherein said tracing sleeve comprises a friction fitting for a writing utensil when said sleeve is inserted over a writing utensil working end.

11. The tracing assembly of claim 9, wherein each of said tracing flanges comprise different offset lengths adapted for tracing around objects at different distances.

12. The tracing assembly of claim 9, wherein at least one of said tracing flange has a flat end.

13. The tracing assembly of claim 9, wherein at least one of said tracing flange has a pointed end.

14. The tracing assembly of claim 9, wherein at least one of said tracing flange has a rounded end.

15. The tracing assembly of claim 8, wherein:
said tracing flange further comprises an upper surface and a first and second edge;
measurement indicia along said upper surface and along at least one of side first and second edges.
